(19) United States
(12) Patent Application Publication
(10) Pub. No.: US 2007/0071244 A1
(43) Pub. Date: Mar. 29, 2007

(54) QKD station with efficient decoy state capability

(75) Inventor: Michael J. LaGasse, Nahant, MA (US)

Correspondence Address: OPTICUS IP LAW, PLLC, 7791 ALISTER MACKENZIE DRIVE, SARASOTA, FL, 34240, US

(73) Assignee: MagiQ Technologies, Inc.

(21) Appl. No.: 11/236,468

(22) Filed: Sep. 27, 2005

(51) Int. Cl. H04L 9/00

(52) U.S. Cl. 380/278

(57) ABSTRACT

A quantum key distribution station having the capability of forming decoy signals randomly interspersed with quantum signals as part of a QKD system is disclosed. The QKD station includes a polarization-independent high-speed optical switch adapted for use as a variable optical attenuator. The high-speed optical switch has a first attenuation level that results in first outgoing optical signals in the form of quantum signals having a mean photon number μ_{Q}, and a second attenuation level that results in second outgoing optical signals as decoy signals having a mean photon number PD. The attenuation level is randomly set during QKD system operation so that the decoy signals are randomly interspersed with the quantum signals.

### FIELD OF THE INVENTION

The present invention relates to quantum cryptography, and in particular relates to systems for and methods of enhancing the security of a QKD system through the use of decoy states.

### BACKGROUND OF THE INVENTION

Quantum key distribution involves establishing a key between a sender (“Alice”) and a receiver (“Bob”) by using weak (e.g., 1 photon per pulse) optical signals (“quantum signals”) transmitted over a “quantum channel.” The security of the key distribution is based on the quantum mechanical principle that any measurement of a quantum system in unknown state will modify its state. As a consequence, an eavesdropper (“Eve”) that attempts to intercept or otherwise measure the quantum signal will introduce errors into the transmitted signals, thereby revealing her presence.

The general principles of quantum cryptography were first set forth by Bennett and Brassard in their article “Quantum Cryptography: Public key distribution and coin tossing,” IEEE Proceedings of the International Conference on Computers, Systems and Signal Processing, Bangalore, India, Dec. 10-12, 1984, pp. 175-179. Specific QKD systems are described in the publication by C. H. Bennett et al., entitled “Experimental Quantum Cryptography,” J. Cryptology 5: 3-28 (1992), in the publication by C. H. Bennett, entitled “Quantum Cryptography Using Any Two Non-Orthogonal States”, Phys. Rev. Lett. 68 3121 (1992), and in U.S. Pat. No. 5,307,410 to Bennett (the '410 patent). The general process for performing QKD is described in the book by Bouwmeester et al., “The Physics of Quantum Information,” Springer-Verlag 2001, in Section 2.3, pages 27-33.

The QKD system described in the '410 patent is a so-called “one-way” system wherein signals are sent from one QKD station (say, Alice) to another QKD station (Bob). The article by Ribordy et al., entitled “Automated ‘Plug and play” quantum key distribution,” Electronics Letters Vol. 34, No. 22 Oct. 29, 1998 (“the Ribordy paper”) and U.S. Pat. No. 6,188,768 each describe a so-called “two way” system wherein quantum signals are sent from a first QKD station (Bob) to the second QKD station (Alice) and then back to the first QKD station (Bob). Typically, the quantum signals sent from the first QKD station to the second QKD station are relatively strong (e.g., hundreds or thousands of photons per pulse on average), and are attenuated down to quantum levels (i.e., one photon per pulse or fewer, on average) at the second QKD station prior to being returned to the first QKD station. The two-way QKD system employs an autocompensating interferometer first invented by Dr. Joachim Meier of Germany and published in 1995 (in German) as “Stabile Interferometrie des nichtlinearen Brechzahl-Koeffizienten von Quarzglasfasern der optischen Nachrichtentechnik,” Joachim Meier. —Als Ms. gedr.—Düsseldorf: VDI-Verl., Nr. 443, 1995 (ISBN 3-18-344308-2). Because the Meier interferometer is autocompensated for polarization and thermal variations, the two-way QKD system based thereon is less susceptible to environmental effects than a one-way system.

Most conventional QKD systems employ a multi-photon source, such as a laser, and attenuate multi-photon pulses to achieve single-photon quantum signals (pulses), i.e., light pulses having a mean photon number μ≦1. This is called “weak coherent pulse” or WCP QKD. Other QKD systems employ a single-photon source to generate the quantum signals. In prior art QKD systems that use a single-photon source, effort is made to suppress or discard the multi-photon signals generated by the single-photon source. An attack on the multiple-photon pulses can prove very effective for Eve if she can take advantage of the large channel loss. Thus, the ability to detect Eve changing the efficiency of the delivery of single versus multi-photon pulses from Alice to Bob is the crucial element in maintaining system security in the presence of loss.

One type of security safeguard against eavesdropping on multi-photon pulses is the decoy state method. One such method is proposed by Hwang in his article entitled “Quantum key distribution with high loss: toward global secure communication,” published at arXiv:quant-ph/0211153 v5, May 19, 2003. In the decoy state method, Alice modulates the mean photon number randomly between two values, such as 0.5 and 0.25, wherein one of the values represents the decoy state. The decoy states allows Alice to determine whether Eve is taking advantage of the channel loss and performing certain type of attack—say, for example, a PNS attack or an unambiguous state discrimination (USD) attack—by checking the loss (i.e., bit error rates) of the decoy state signals as compared to that of the quantum signals. Generally, the two different values for the mean photon number are chosen based on the QKD system parameters in order to yield the best statistics for the two states.

Zhao et al., in their article entitled “Experimental decoy state quantum key distribution over 15 km,” published on Mar. 25, 2005 at http://arxiv.org/PS_cache/quant-ph/pdf/0503/0503192v2.pdf, and which article is incorporated by reference herein, discloses a modification to a two-way QKD system that allows for the generation of decoy state pulses along with weak coherent state (“quantum state”) pulses. With reference to FIG. 2 of the Zhao article, the modification involves adding two acousto-optical modulators (AOMS)—a “decoy” AOM” driven by a “decoy generator,” and an upstream “compensating AOM driven by a ” compensating generator.” The decoy generator is coupled to an ordinary photo-detector, which in turn is optically coupled to the optical fiber connecting the decoy AOM to the phase modulator (PM) and faraday mirror (FM). The compensating AOM and associated compensating generator are used to shift the frequency of the signal to maintain alignment between Alice's and Bob's interferometers. While the Zhao modification suited the experimental purposes of the article for studying decoy state protocols, it is unduly complex and unwieldy for a commercial QKD system.

### SUMMARY OF THE INVENTION

A first aspect of the invention is a QKD station capable of forming quantum signals with interspersed decoy signals. The QKD station includes a modulator adapted to either phase modulate or polarization-modulate optical signals passing therethrough. The QKD station also includes a polarization-independent optical switch adapted for use as a variable optical attenuator. The optical switch is optically coupled to the modulator and is adapted to attenuate optical signals passing therethrough by a select amount based on inputted drive signals. The QKD station also includes an optical switch driver operably coupled to the optical switch and adapted to provide the drive signals thereto. The drive signals cause the optical switch to randomly provide first and second levels of attenuation that result in outgoing optical pulses having either a first mean photon number μ_{Q} associated with quantum signals or a second mean photon number μ_{D} associated with decoy signals. The randomness of the drive signals causes the decoy signals to be randomly interspersed with the quantum signals.

A second aspect of the invention is a method of generating in a QKD station quantum signals randomly interspersed with decoy signals. The method includes passing randomly modulated optical pulses through a high-speed optical switch adapted for use a variable optical attenuator. The method also includes randomly driving the optical switch so as to provide first and second select levels of attenuation of the optical pulses so as to create quantum signals having a mean photon number μ_{Q} interspersed with decoy signals having a mean photon number PD.

### BRIEF DESCRIPTION OF THE DRAWINGS

FIG. 1 is a schematic diagram of a generalized QKD system having QKD stations “Alice” and “Bob” optically coupled by an optical fiber link, illustrating different types of optical signals typically exchanged between Alice and Bob;

FIG. 2 is a schematic diagram of an example embodiment of QKD station Alice according to the present invention, wherein Alice is capable of efficiently generating decoy signals randomly interspersed with quantum signals for a two-way QKD system according to FIG. 1; and

FIG. 3 is a schematic diagram of an example embodiment of QKD station Alice according to the present invention, wherein Alice is capable of efficiently generating decoy signals randomly interspersed with quantum signals for a one-way QKD system according to FIG. 1.

The various elements depicted in the drawings are merely representational and are not necessarily drawn to scale. Certain sections thereof may be exaggerated, while others may be minimized. The drawings are intended to illustrate various embodiments of the invention that can be understood and appropriately carried out by those of ordinary skill in the art.

### DETAILED DESCRIPTION OF THE INVENTION

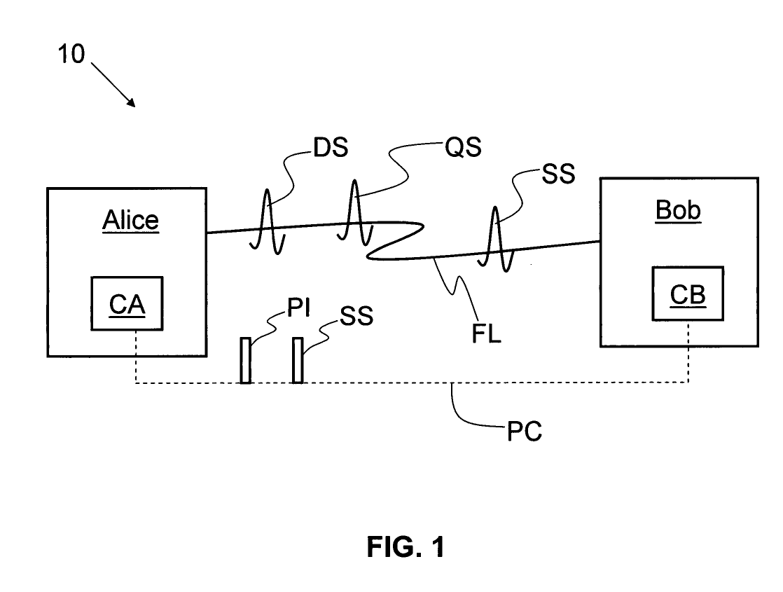

FIG. 1 is a schematic diagram of a generalized QKD system 10 that includes a first QKD station called “Alice” and a second QKD station called “Bob” operably coupled by an optical fiber link FL. Alice and Bob have respective controllers CA and CB that control the respective operations of the QKD stations, that communicate to coordinate the overall synchronization of the QKD system operation, and that exchange and process information (e.g., sifting, privacy amplification, etc.) in order to establish a final secure quantum key. Optical fiber link FL is adapted to carry weak optical pulses from Alice to Bob over a quantum channel. Here, weak optical pulses are defined as optical pulses having a mean photon number μ≦1. Quantum signals QS, which are used to establish a shared quantum key, are weak optical pulses exchanged over a quantum channel. Decoy state signals DS (hereinafter, “decoy signals”), generated as described below, may also be weak optical pulses having a different mean photon number p than the quantum signals QS. Decoy state signals DS are also exchanged over the quantum channel.

Optical fiber link FL may also carry optical signals associated with other channels such as a synchronization signal SS associated with a synchronization channel that synchronizes the operation of Alice and Bob in the key exchange process via controllers CA and CB. In addition, optical fiber link FL is capable of carrying multi-photon optical signals (pulses), such as multi-photon decoy signals DS. In other embodiments, QKD system 10 has a separate public channel that is not necessarily carried over optical fiber link FL and that operably connects controllers CA and CB. The public channel allows for communication of, for example, synchronization information via synchronization signals SS and/or for the exchange of public information via a public information signal SI. In one example, public information signal SI contains public information that relates to the nature and type of exchanged quantum signals and decoy signals as part of the process of obtaining a secure shared quantum key.

### Two-Way System Example Embodiment

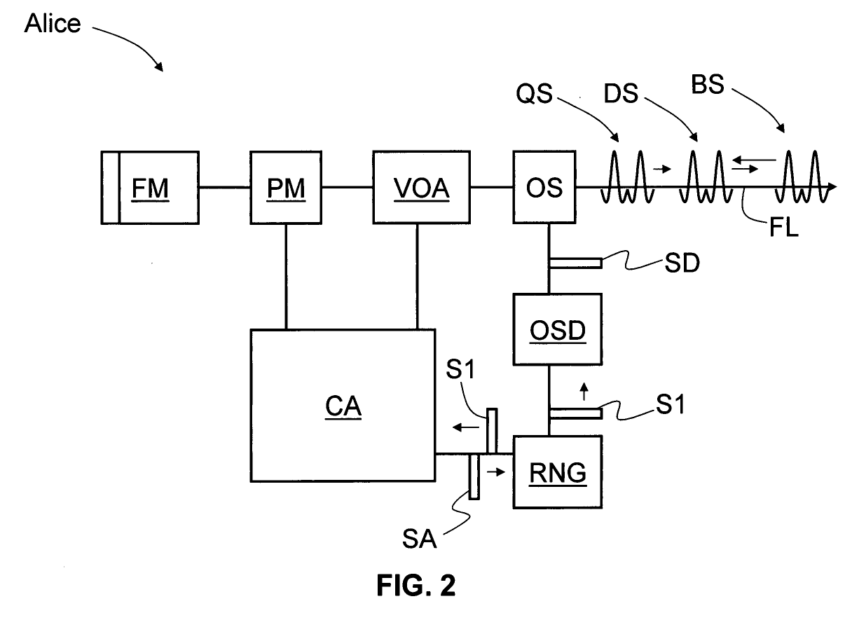

FIG. 2 is a schematic diagram of an example embodiment of QKD station Alice according to the present invention, wherein Alice is capable of efficiently randomly interspersing decoy signals DS with quantum signals QS in a two-way QKD system. The Alice of FIG. 2 includes the usual elements found in the prior art two-way Alice—namely, a Faraday mirror FM, a phase modulator PM, a variable optical attenuator VOA, and a controller CA operatively coupled to the phase modulator and the variable optical attenuator. Note that the position of the optical attenuator in the system is not critical—and in fact need not be part of the system in an example embodiment wherein optical switch OS can provide sufficient attenuation.

Rather than adding two more VOAs and their attendant drivers to the system in the manner according to Zhao, Alice of FIG. 2 according to the present invention simply adds a polarization-independent high-speed optical switch OS driven by an optical switch driver OSD. An example of a suitable optical switch OS is available from EOSPACE, Inc., 8711 148^{th} Avenue N.E., Redmond, Wash. 98052, as model no. SW 2x2-D00-SFU-SFU.

Optical switch driver OSD is operably coupled to optical switch OS and to a random number generator RNG, which is operably coupled to controller CA. Optical switch OS is adapted for use in the present invention as a polarization-independent variable optical attenuator, wherein the amount of attenuation is provided by a drive signal SD from optical switch driver OSD. For example, when drive signal SD=0 volts, optical switch OS is inactive and provides minimum attenuation (˜0 dB), whereas when SD=15 volts, attenuation is maximum (e.g., ˜23 dB). In between, the attenuation varies in a defined manner corresponding to the voltage of drive signal SD. Accordingly, a set level of attenuation for optical signals entering and leaving Alice can be provided by optical switch OS through providing the optical switch with drive signals SD having the appropriate voltage. This avoids the complexity of using acousto-optic modulators, which require high-power RF drivers, and which causes frequency shifts that need compensation.

The Alice of FIG. 2 is part of two-way embodiment of QKD system 10 of FIG. 1. As such, relatively strong optical signals BS from Bob are send to Alice. Optical signal BS includes two relatively strong (i.e., non-quantum) orthogonally polarized optical pulses that start out as a single optical pulse and that are phase-encoded and recombined back at Bob to form a single optical pulse that contains the phase-encoding information.

In particular, optical signal BS is received by Alice, which randomly modulates one of the pulses at phase modulator PM by the random selection of a phase modulation by controller CA. Faraday mirror FM changes the polarization of each pulse by 900 and the pulses return to Bob after passing through the variable optical attenuator VOA and optical switch OS. When exchanging quantum signals QS between Alice and Bob, variable optical attenuator VOA and optical switch OS are set so that the pulses in incoming signal BS are attenuated to form quantum signal QS having a select mean photon number μ_{Q} when the pulses are returned to Bob.

In order to randomly intersperse decoy signals DS having a mean photon number μ_{D} with quantum signals QS of mean photon number μ_{Q}, controller CA sends a control signal SA to random number generator RNG during QKD system operation. This causes the random number generator to generate a random number signal SI, representative of a random number, and provide the signal to optical switch driver OSD. In response to random number signal S1, optical switch driver OSD provides a corresponding drive signal SD to optical switch OS, which sets the optical switch to a select attenuation. Signals SA, S1 and SD are timed so that optical switch OS is set to the select attenuation when an optical signal BS from Bob arrives at Alice and/or when reflected pulses leave Alice. Note that random number signal S1 is also provided to controller CA, which records the random numbers represented by the random number signal during the operation of the system. In an example embodiment, the random number is a single-bit random number.

Optical switch driver OSD is programmed to receive random number signal S1 and in response thereto generate a corresponding drive signal SD. For example, random number signal S1 may represent a one bit random number with only two possible values, say 0 and 1. Optical switch driver OSD may generate a drive signal SD of zero volts in response to signals S1 representing a 0, so that the combined attenuation provided by optical switch OS and variable optical attenuator VOA result in quantum signals QS leaving Alice having a mean photon number of, say for example, μ_{Q}=0.5.

On the other hand, in response to a signal S1 representing a value of 1, optical switch driver OSD generates a drive signal SD of 5 volts, timed to attenuate the outgoing pulses, which causes optical switch OS to provide an attenuation of 3 dB, which for quantum signals having μ_{Q}=0.5 results in decoy signals DS having μ_{D}=0.25. During QKD system operation, the result is that decoy signals DS are randomly interspersed with quantum signals QS.

Further, Alice's recording in controller CA of the random numbers used to generate the quantum signals QS and decoy signals DS allows Bob and Alice to compare the results of Bob's detecting both types of signals. Appropriate selection of random numbers generated by random number generator RNG and appropriate settings for optical switch driver OSD in response thereto allows for the ratio of the number quantum signals QS to the number of decoy state signals DS to be set to a desired level. Also, because the signals from Bob make a round trip through Alice, optical switch OS can be activated for a time period sufficiently long for the signals to make two trips through the optical switch. In this case, using the example above, the attenuation level of optical switch OS is set to 1.5 dB (as opposed to the one-pass setting of 3 dB).

Once a suitable number of weak optical signals (both QS and DS) are exchanged between Alice and Bob, they share the information relating to which signals were quantum signals and which signals were decoy signals. The statistics of each signal type are then analyzed to ascertain whether or not an eavesdropper was present during the key exchange process.

It should be noted that in other example embodiments, μ_{Q}<μ_{D}, e.g., by suitable programming of optical switch driver OSD so that quantum signals QS are attenuated more than the decoy signals DS.

### One-Way System Example Embodiment

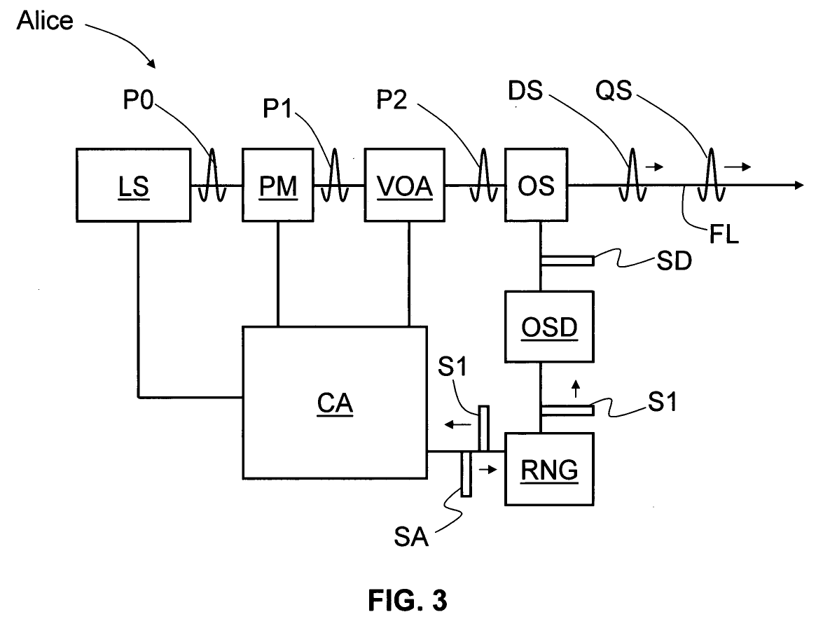

FIG. 3 is a schematic diagram of an example embodiment of QKD station Alice according to the present invention, wherein Alice is capable of efficiently randomly interspersing decoy signals DS with quantum signals QS in a one-way QKD system. The Alice of FIG. 3 includes the usual elements found in the prior art one-way Alice—namely, a laser source LS, a modulator M (e.g., a polarization or phase modulator), a variable optical attenuator VOA, and a controller CA operatively coupled to the laser source, the phase modulator and the variable optical attenuator. Again, the position of the variable optical attenuator is not critical—and in fact need not be part of the system in an example embodiment wherein optical switch OS can provide sufficient attenuation.

The Alice of FIG. 3 according to the present invention further includes polarization-independent high-speed optical switch OS arranged downstream of variable attenuator VOA, along with optical switch driver OSD and random number generator RNG, as discussed above in the previous example embodiment.

The operation of Alice of FIG. 3 is essentially the same as Alice of FIG. 2, except that instead of receiving strong signals BS from Bob, Alice generates her own strong optical signals (pulses) P0 using laser source LS. Signals P0 pass through modulator M and are randomly polarization-modulated or phase-modulated, thereby creating randomly modulated optical signals P1. Optical signals P1 are then attenuated by variable optical attenuator VOA to create attenuated optical signals P2. In an example embodiment, attenuated optical signals P2 have a mean photon number μ₂=μ_{Q} so that optical signals P2 are the same as quantum signals QS.

Optical signals P2 then pass through optical switch OS, which is controlled as described above in connection with the Alice of FIG. 2. Thus, when optical switch OS is in the “off” state, optical signals P2 pass directly through the optical switch and leave Alice as quantum signals QS with mean photon number μ_{Q}. On the other hand, when optical switch OS is activated, optical signals P2 are further attenuated to form decoy signals DS with μ_{Q}. Again, it should be noted that in other example embodiments, μ_{Q}<μ_{D}, e.g., by suitable programming of optical switch driver OSD so that quantum signals QS are attenuated more than the decoy signals DS.

Once a suitable number of optical signals (both QS and DS) are exchanged between Alice and Bob, they share the information relating to which signals were quantum signals and which signals were decoy signals. The statistics of each signal type are then compared to ascertain whether or not an eavesdropper was present during the key exchange process.

In the foregoing Detailed Description, various features are grouped together in various example embodiments for ease of understanding. The many features and advantages of the present invention are apparent from the detailed specification, and, thus, it is intended by the appended claims to cover all such features and advantages of the described apparatus that follow the true spirit and scope of the invention. Furthermore, since numerous modifications and changes will readily occur to those of skill in the art, it is not desired to limit the invention to the exact construction, operation and example embodiments described herein. Accordingly, other embodiments are within the scope of the appended claims.

What is claimed is:

1. A QKD station capable of forming quantum signals with interspersed decoy signals, comprising:
a modulator adapted to either phase modulate or polarization-modulate optical signals passing therethrough;
a polarization-independent optical switch adapted for use as a variable optical attenuator, the optical switch optically coupled to the modulator and adapted to attenuate optical signals passing therethrough by a select amount based on inputted drive signals; and
an optical switch driver operably coupled to the optical switch and adapted to provide said drive signals thereto so that the optical switch randomly provides first and second levels of attenuation that result in outgoing optical pulses having either a first mean photon number μ_{Q} associated with quantum signals or a second mean photon number μ_{D} associated with decoy signals that are randomly interspersed with the quantum signals.

2. The QKD station of claim 1, wherein the modulator is a phase modulator, and further including a Faraday mirror arranged so as to reflect incoming pulses of light from a second QKD station back through the phase modulator and the optical switch so as to travel back to the second QKD station.

3. The QKD station of claim 1, further including a light source arranged upstream of the modulator and adapted to generate the optical signals that pass through the modulator and the optical switch.

4. The QKD station of claim 1, further including:
a controller; and
a random number generator operably coupled to the controller and to the optical switch driver, the random number generator adapted to generate a random number signal representative of a random number and provide the random number signal to the optical switch driver and to the controller.

5. The QKD station of claim 1, wherein μ_{Q}>μ_{D}.

6. The QKD station of claim 1, wherein μ_{D}>μ_{Q}.

7. The QKD station of claim 1, further including an optical attenuator arranged adjacent either the modulator or the optical switch so as to attenuate optical signals passing therethrough.

8. A method of generating in a QKD station quantum signals randomly interspersed with decoy signals, comprising:
passing randomly modulated optical pulses through a high-speed optical switch adapted for use a variable optical attenuator; and
randomly driving the optical switch so as to provide first and second select levels of attenuation of the optical pulses so as to create quantum signals having a mean photon number μ_{Q} interspersed with decoy signals having a mean photon number PD.

9. The method of claim 8, including providing a third select level of attenuation of the optical pulses with an optical attenuator prior to the optical pulses leaving the QKD station.

10. The method of claim 8, wherein randomly driving the optical switch includes providing random number signals representative of random numbers to an optical switch driver operably coupled to the optical switch, wherein the optical switch driver is adapted to receive the random number signals and generate therefrom corresponding drive signals that are provided to the optical switch and that correspond to the first and second select attenuation levels.

11. The method of claim 8, wherein the first and second select attenuation levels are such that μ_{Q}>μ_{D}.

12. The method of claim 8, including passing the optical pulses only once through a modulator in forming the randomly modulated optical pulses.

13. The method of claim 8, including passing the optical pulses twice through a modulator in forming the randomly modulated optical pulses.

14. The method of claim 8, wherein the QKD station is a first QKD station operably coupled to a second QKD station in order to perform quantum key exchange, and further including:
storing in the first QKD station information relating to the random driving of the optical switch;
sharing said information with a second QKD station to identify which optical signals received by the second QKD station were quantum signals and which were decoy signals; and
analyzing data relating to the quantum signals and the decoy signals sent by the first QKD station and detected by the second QKD station in order to determine whether an eavesdropper interfered with the quantum key exchange.
